(19) United States
(12) Patent Application Publication
(10) Pub. No.: US 2015/0324778 A1
(43) Pub. Date: Nov. 12, 2015

(54) PHONE-NUMBER-BASED PAYMENT FUNDING CONFIRMATION

(71) Applicant: TOLLSHARE, INC., Danville, CA (US)

(72) Inventors: Murali M. Karamchedu, Portland, OR (US); Ravi Asnani, Los Angeles, CA (US)

(73) Assignee: TOLLSHARE, INC., Danville, CA (US)

(21) Appl. No.: 14/274,661

(22) Filed: May 9, 2014

(51) Int. Cl. G06Q 20/16; G06Q 20/42

(52) U.S. Cl. CPC G06Q 20/16; G06Q 20/425

(57) ABSTRACT

Methods, apparatuses, and computer-readable media directed to phone-number-based payment authorization are described. A phone-number-based payment authorization system (PBA) may be configured to authorize payments from a payer party to a payee party based on a phone number of a payer party. The PBA may be configured to receive a payment authorization request, which may include a payment amount as well as a phone number for the payer party. In response to receipt of the payment authorization request, the PBA may make a determination of whether the payer is capable of making a payment of the requested amount. The determination may include determination of payment capabilities from various payment servicers. The PBA may also make an authorization request from a third-party authorizing entity based on identifying and/or financial information known to the PBA. Other embodiments may be described and/or claimed.

### TECHNICAL FIELD

The present disclosure relates to the field of data processing, in particular, to apparatuses, methods and storage media associated with facilitating authorization of payments through use of phone numbers.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Parties engage in financial transactions, and in particular transactions involving payment, every day. However, it is sometimes difficult for parties to easily utilize non-cash payments. In particular, parties may wish to obtain authorization for non-cash payments before completing a transaction. For example, if a vendor is transacting to sell an expensive good to a customer, the vendor may wish to obtain surety that the customer has adequate credit or account funds to pay for the good. However, obtaining such authorization may difficult, and frequently requires the use of credit or account information, such as a credit card or checking account number (or even possession of the physical credit card itself). However, the customer may be uninterested or unwilling to provide sensitive information to a vendor, or may not have such information readily available when conducting the transaction. As such, obtaining authorization may be difficult or impossible using current techniques.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for phone-number-based payment authorization, in accordance with various embodiments.

FIG. 2 illustrates an example process for phone-number-based payment authorization, in accordance with various embodiments.

FIG. 3 illustrates an example process for setting up phone-number-based payment authorization, in accordance with various embodiments.

FIG. 4 illustrates an example process for requesting authorization for a payment, in accordance with various embodiments.

FIG. 5 illustrates an example process for confirming authorization of a payment, in accordance with various embodiments.

FIG. 6 illustrates an example computing environment suitable for practicing various aspects of the present disclosure, in accordance with various embodiments.

FIG. 7 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality. The term “messaging” as used herein may include instant messaging, personal messaging, text messaging, email, and so forth. Text messages may include messages sent using, e.g., short messaging service (SMS), or messages containing image, video, and sound content, e.g., multi-media messaging service (MMS).

In various embodiments, methods, systems, apparatuses, devices, and computer-readable media directed to phone-number-based payment authorization are described. In various embodiments, a phone-number-based payment authorization system (PBA) may be configured to authorize payments from a payer party (the party making payment) to a payee party (the party receiving payment) based on a phone number of a payer party. The PBA may be configured to receive a payment authorization request for a payment to be made from the payer party to a payee party. The payment authorization request may be sent, in various embodiments, from the payee party or the payer. The payment authorization request may include a payment amount as well as a phone number for the payer party. For example, a payee vendor may send a request to the PBA to request payment authorization for payer customer to make a payment of a particular amount for the sale of goods or services. In various embodiments, the payment authorization request may be sent via various means, including a text message sent via a messaging protocol, an email, one or more application programming interface (“API”) calls, and/or other communication techniques.

In response to receipt of the payment authorization request, the PBA may be configured, in various embodiments, make a determination of whether the payer is capable of making a payment of the requested amount. The determination may include determination of payment capabilities from various payment servicers, such as credit card servicers, banks, etc. In other embodiments, the PBA may be configured to make an authorization request from a third-party authorizing entity. In various embodiments, the PBA may be facilitated in making this authorization request based on identifying and/or financial information known to the PBA.

In various embodiments, the phone-number-based payment authorization techniques described herein may provide for easier conducting of payment between parties, while protecting sensitive information of the payer. For example, by providing facility for requesting a payment authorization using a near-universally recognizable identifier, such as a phone number, the payer and/or payee may be facilitated in performing transactions in a manner that is easier, and which may require less equipment, than by using more traditional authorization techniques, such as check-based or credit-card-based authorization systems. Additionally, by allowing the use of a phone number to facilitate payments over commonly-used communication media, such as text messaging or mobile applications, the PBA may facilitate payment by not requiring special applications, hardware, or other equipment or resources to authorize payment than are commonly available to everyday payers and payees. At the same, sensitive financial information of the payer party, such as his/her credit/debit card or checking account information may be protected, and reduce the risk of fraud. Other benefits of the techniques described herein may be described below.

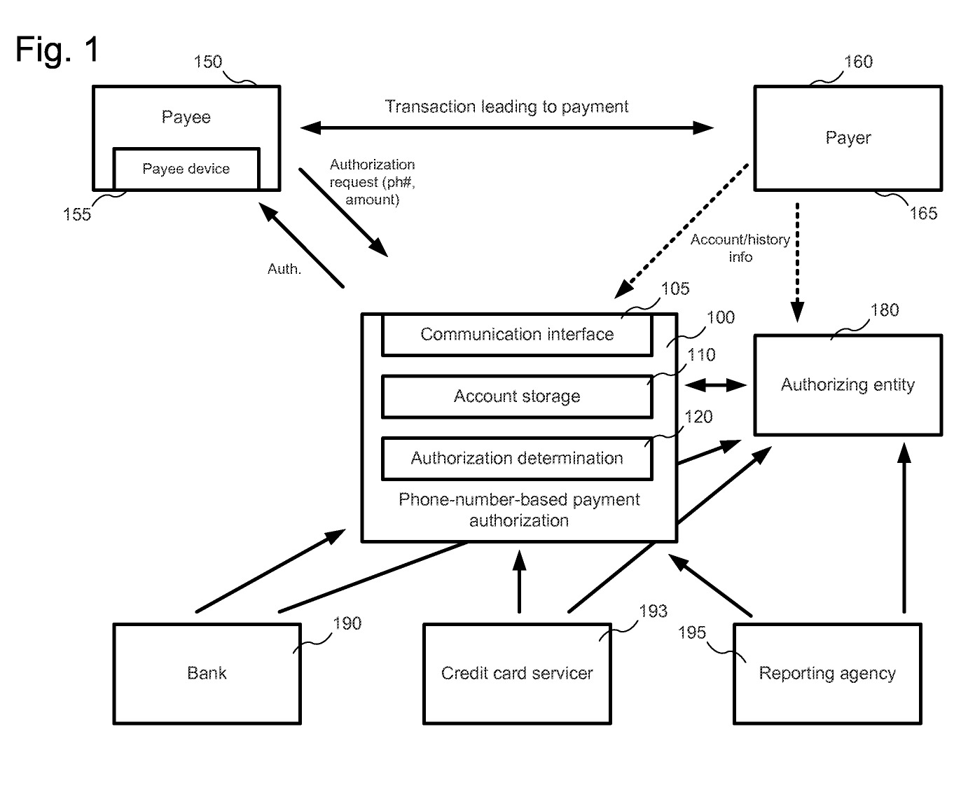

Referring now to FIG. 1, an example arrangement for phone-number-based payment facilitation may be illustrated in accordance with various embodiments. In various embodiments, while examples of particular activities may be described, no particular requirements may be made on the type of activity being performed by parties utilizing the PBA to facilitate phone-number-based payments. It may also be noted that, while particular entities and information flows are illustrated in FIG. 1, in various embodiments, entities and modules may be omitted, split into further entities or modules, or combined, and that other information may be sent between entities.

In various embodiments, a phone-number-based payment system 100 (PBA 100) may be configured to communicate with a payee device 155 and/or a payer device 165 to facilitate payment between a respective payee 150 and payer 160 associated, respectively, with the devices. The payee device 155, payer device 165, and/or PBA 100 may include one or more computing devices and/or computing systems, including desktop computers, laptop computers, mobile phones, tablet computers, and/or other mobile or non-mobile devices. In various embodiments, the payee device 155 and/or payer device 165 may include various devices configured to facilitate transactions, such as, for example, point-of-sale devices, cash registers, etc. In other examples, the payee device 155 may include a device configured to facilitate payment via a credit or debit card, such as a dedicated card reader, or a mobile device executing a credit/debit card payment application. Such devices may be used, in various embodiments, even in scenarios where the PBA 100 facilitates payment authorization without requiring use of a credit or debit card. In various embodiments, payment may be requested in support of a transaction that has been performed between the payee 150 and the payer 160.

In various embodiments, the payment authorization request, as well as other communication associated with the techniques described herein, may be sent and received communication interface 105 of the PBA 100. As discussed above, in various embodiments, these communications may be facilitated at the payee device 155 and/or payee device 165 using various means, such as messaging via a text messaging application using a text messaging protocol, such as a short message service (SMS) or multimedia messaging service (MMS). In some such embodiments, a messaging carrier (not illustrated) may be configured to communicate with payee device 155, payer device 165, and the PBA 100 to mediate messages. In other embodiments, these communications may be facilitated using dedicated payment authorization applications (not illustrated) at the payee device 155 and/or the payer device 165.

In various embodiments, the PBA 100 may be configured to receive a payment authorization request from the payee device 155. In various embodiments, the payment authorization request may include a payment amount, as well as a phone number identifying the payer. In some embodiments, the payment authorization request may include identifying information other than a phone number for the payer, such as, for example the payer's name, email address, physical address, etc. In some embodiments, the payment authorization request may also include information about the payee and/or the transaction for which payment authorization is being requested, such as, for example, transaction type, a description of goods or services associated with the payment authorization, payment terms, etc.

In various embodiments, the PBA 100 may be configured, in response to receipt of the payment authorization request from the payee device 155 or the payer device 165, to determine whether the payer 160 may make the payment for which the request was made. The PBA 100 may be configured to then send confirmation of the authorization to the payee 150, such as at the payee device 155. In some embodiments, the PBA 100 may be configured to reply to the payment authorization request with a confirmation code that indicates that the requested payment is authorized. In such embodiments, this confirmation code may be given from the requesting party (such as the payer) to the requesting party (such as the payee) in order that the payee may then confirm the requested authorization with the PBA 100 using the confirmation code itself. In various embodiments, the payee 150 may use the received confirmation to then request payment from the payer 160.

In various embodiments, the PBA 100 may include one or more modules for performing techniques described herein. In various embodiments, the PBA 100 may include an account storage 110 (AS 110), which may be configured to store information about various persons, including, but not limited to, payees who may be paid and payers who may pay. In various embodiments, the AS 110 may be located internally or externally to the PBA 100, and may include various techniques and implementations, as may be understood. In various embodiments, the AS 110 may include phone number information for the payer 160; the phone number information may be the phone number of the payer device 165. In other embodiments, the AS 110 may include financial information for the payer 160, such as debit or credit account information, payment service information, financial history information, etc. In various embodiments, the AS 110 may also include identifying information for the payer 160; this information may be utilized, in some embodiments, in facilitating use of a third-party authorization entity to make payment authorization determinations for the PBA 100. In various embodiments, the AS 110 may also include information about a payee 150, such as a communication address through which the payee may be identified and/or communicated with; this communication address may be associated with the payee device 155.

In various embodiments, the PBA 100 may include an authorization determination module 120 (AD 120), which may be configured to respond to receipt of a payment request from the payment application 155 of the payee device 155 to initiate a payment process, as well as to report back to the payee with a payment confirmation when the payment is complete. The AD 120 may also be configured, in various embodiments, to receive a payment authorization request with a payment amount from the payee 150 or payer 160, and to make a determination of whether the payer 160 may make the payment. In various embodiments, the AD 120 may be configured to make a determination by requesting a determination from a third-party authorizing entity 180. In other embodiments, the AD 120 may be configured to make a determination based on information that is available to the AD 120. In various embodiments, the AD 120 and/or third-party authorizing entity 180 may be configured to make determinations for authorization determination based on information obtained from various entities. Examples of such entities include the payer 160 itself, one or more banks 190, one or more credit card servicers 193, and one or more credit reporting agencies 195. Particular examples of determination for authorization of payments are described below.

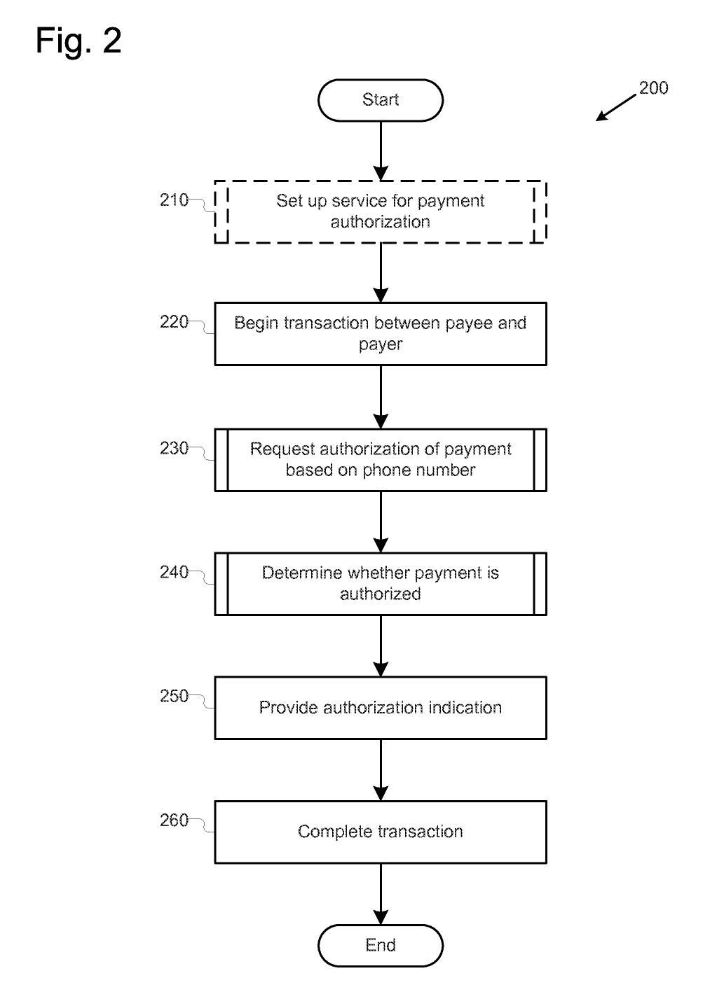

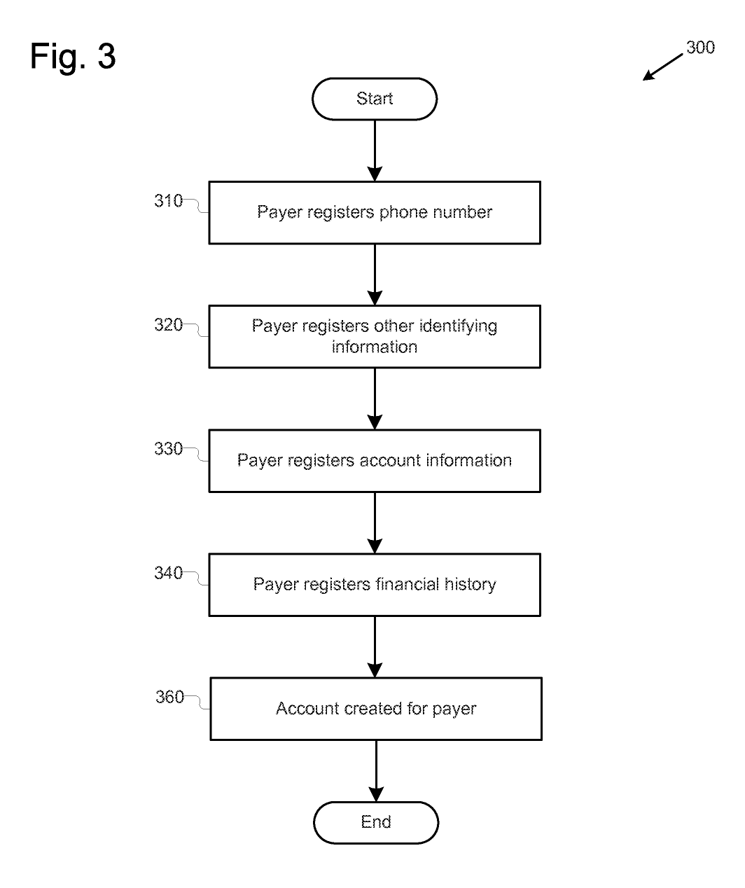

Referring now to FIG. 2, an example process for phone-number-based payment authorization is illustrated in accordance with various embodiments. While FIG. 2 illustrates particular operations in a particular order, in various embodiments, the operations may be combined, split into parts, and/or omitted. The process may begin at operation 210, where the payee 150 and/or payer 160 may, in association with the AS 110, set up service to receive and/or make payments, respectively. In various embodiments, operation 210 may not be performed for every payment that is made, but instead may be performed prior to issuance of payments. Particular examples of operation 210 may be described below with reference to process 300 of FIG. 3. Next, at operation 220, the payee 150 and payer 160 may begin a transaction. In various embodiments, various types of transactions may be performed without restriction on the techniques described herein. For example, transactions may include a purchase of goods, a contract for services, a gift from one party to another, etc.

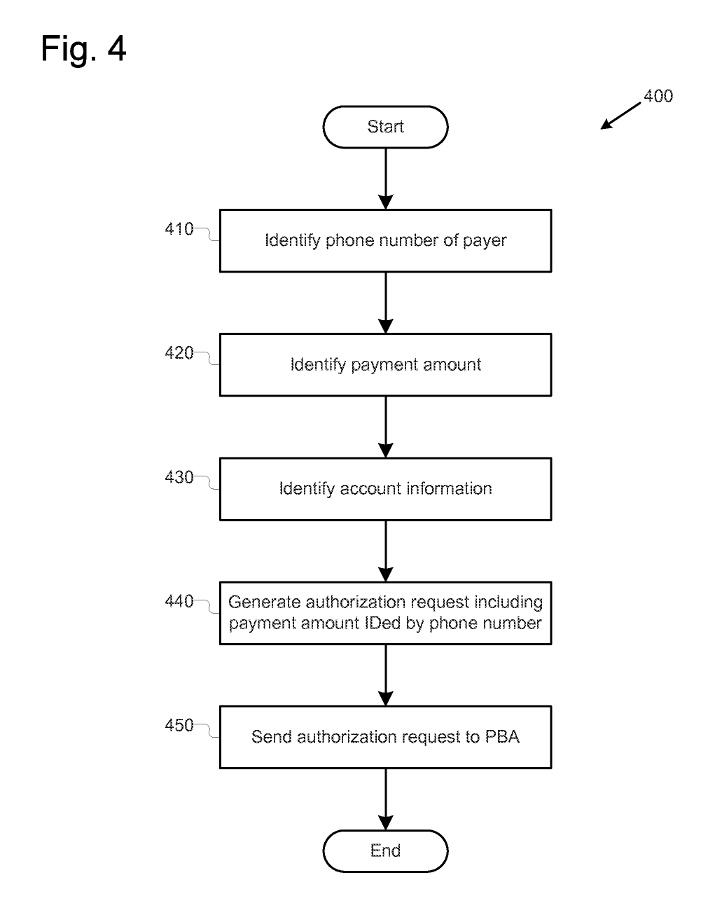

Next, at operation 230, the AD 120 may receive a payment authorization request from the payee 150 or payer 160. For example, the payee 150 may send a text message to the PBA 100 using the payee device 155, which may be received and processed by the AD 120. Particular examples of operation 230 may be described below with reference to process 400 of FIG. 4. It may be noted that, in other embodiments, the AD 120 may receive the payment authorization request from the payer 160 instead.

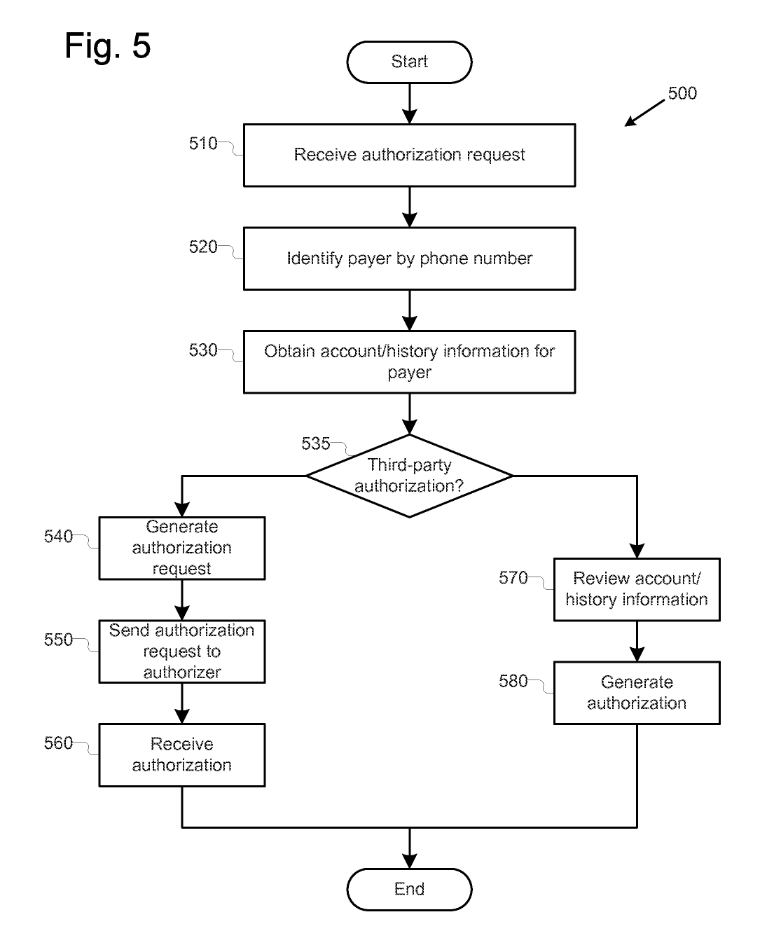

Next, at operation 240, the AD 120 of the PBA 100 may determine whether payment is authorized for the payer 160. Particular examples of operation 240 may be described below with reference to process 500 of FIG. 5. Next, at operation 250, the AD 120 may confirm the authorization. In some embodiments, the authorization may be confirmed simply by sending a confirmation message to the payee 150. In other embodiments, the PBA 100 may be configured to provide an authorization code, such as to the payer 160, that may later be used to confirm pre-authorization, such as by the payee 150 making a confirmation request to the PBA 100 at a later time. Next, at operation 260, the payee 150 and payer 160 may complete the transaction for which authorization was performed. Process 200 may then end.

Referring now to FIG. 3, an example process 300 for setting up phone-number-based payment authorization is illustrated in accordance with various embodiments. While FIG. 3 illustrates particular operations in a particular order, in various embodiments, the operations may be combined, split into parts, and/or omitted. In various embodiments, the operations described in process 300 may be performed as one or more implementations of operation 210 of process 200. The process may begin at operation 310, where the payer 160 may register a phone number with the PBA 100. In various embodiments, the payer 160 may register a mobile or landline phone number, or more than one phone number for the payer 160. Next, at operation 320, the payer 160 may register other identifying information for the payer 160, such as for, example, name information, social security information, address information, one or more communication addresses (such as, for example, email or messaging addresses), etc. Next, at operation 320, the payer 160 may register account information. In some embodiments, the registered account information may include account from which payments may be made, such as checking and/or savings accounts, or credit accounts. In other embodiments, the payer 160 may register accounts that payments may not be made from, but from which financial information may be obtained for the payer 160. For example, in some embodiments the PBA may register mortgage accounts, car loan accounts, business loan accounts, etc.

Next, at operation 340, the PBA 100 may register financial history information for the payer 160. For example, the payer 160 may provide one or more credit reports from credit reporting agencies that have financial history information for the payer 160. In other embodiments, the payer 160 may manually register financial history information on an account-by-account, or event-by-event basis. Next, at operation 360, an account may be created for the payer 160. Thereafter, the process may then end.

Referring now to FIG. 4, an example process 400 for requesting authorization for a payment is illustrated in accordance with various embodiments. While FIG. 4 illustrates particular operations in a particular order, in various embodiments, the operations may be combined, split into parts, and/or omitted. In various embodiments, the operations described in process 400 may be performed as one or more implementations of operation 230 of process 200. It may be noted that, while operations are described below in the context of actions and requests made by the payee 150, in other embodiments, one or more operations of process 400 may be performed by the payer 160. The process may begin at operation 410, where the payee 150 may identify a phone number of the payer 160. In various embodiments, the payer 160 may directly provide the phone number to the payee 150, such as verbally or through entry into a keyboard or number pad, or the payee 150 may obtain the phone number from a physical or online form completed by the payer 160. In other embodiments, the payee 150 may obtain the phone number through identification of a phone call made by the payer 160 to the payee 150, such as using caller ID. Next, at operation 420, the payee 150 may identify a payment amount for the payment for which authorization is desired. In various embodiments, the payment amount may be for a single, one-time payment, or may be for a recurring payment. Next, at operation 430, the payee 150 may optionally identify account information for the authorization. For example, the payee 150 may identify one or more specific payment accounts for which authorization is desired. For example, the payee 150 may identify a credit card account of the payer 160 in order to authorize a payment to be made from the credit card account.

Next, at operation 440, the payee 150 may generate a payment authorization request that may include the payment amount and the previously obtained phone number for the payer 160. In various embodiments, to generate the request, the payee 150 may generate a message, such as a text message, with the phone number and payment amount information (as well as account information in some scenarios). In other embodiments, the payee 150 may utilize a dedicate application on the payee device 155 to generate the payment authorization request. Next, at operation 450, the payee 150 may send the payment authorization request to the PBA 100, such as by sending the generated text to the PBA 100, or by submitting the request through a dedicated application. The process may then end.

Referring now to FIG. 5, an example process 500 for confirming authorization of a payment is illustrated in accordance with various embodiments. While FIG. 5 illustrates particular operations in a particular order, in various embodiments, the operations may be combined, split into parts, and/or omitted. In various embodiments, the operations described in process 500 may be performed as one or more implementations of operation 240 of process 200. The process may begin at operation 510, where the AD 120 of the PBA 100 may receive a payment authorization request. In various embodiments, the request may be received via various communications methods, such as via messaging, emails, API calls, and/or other methods. Next, at operation 520, the AD 120 may identify the payer 160 for whom authorization is sought using the entered phone number. In various embodiments, the AD 120 may look up an account for the payer 160 using information stored at the AS 110.

Next, the AD 120 may obtain account and/or history information for the payer 160. In various embodiments, the AD 120 may obtain locally-stored information, such as information registered during operation of process 300 of FIG. 3. In other embodiments, the AD 120 may request and obtain information about accounts of the payer 160 from account holders, such as from a bank 190 or credit card servicer 193. In other embodiments, the AD 120 may request information from a credit reporting agency 195. In various embodiments, the AD 120 may utilize information previously registered with the AS 110, such as name information, social security information, address information, etc., in order to obtain the history or account information from these third parties. As such, in various embodiments, the PBA 100 may provide access or use of information based solely on a phone number, by maintaining identifying information itself, and may use this to make authorization determinations upon request.

Next, at decision operation 535, the AD 120 may determine whether third-party authorization is needed. This determination may be made in various manners. In some embodiments, the AD 120 may be specifically requested to request authorization from a particular account holder, such as a bank or credit card servicer. In other embodiments, the AD 120 may be requested to determine merely whether the payer 160 has sufficient funds and/or credit throughout his or her accounts to make a payment, and may have sufficient information to make this determination without reference to third-parties.

If the AD 120 determines that third-party authorization is needed, then at operation 540, the AD 120 may generate an authorization request of its own. This authorization request may include the payment amount previously requested in the payment authorization request submitted to the PBA 100, as well as identifying information for the payer 160 known to the AD 120. Next, the AD 120 may send the request to the authorizing third party. In various embodiments, the authorizing third party may be identified by the AD 120 based on a specific account requested in the payment authorization request submitted to the PBA 100. In other embodiments, the authorizing third party may be identified by the AD 120 based on account or balance information known to the AD 120. Next, at operation 560, the AD 120 may receive authorization from the third party, an the process may end.

If the AD 120 determines that third-party authorization is not needed, then at operation 570, the AD 120 may review account and/or history information to determine whether payment may be authorized by the AD 120 itself. In various embodiments, the information reviewed may include numbers and types of accounts, payment history, account balances, credit scores, etc. Next, based on the review of the information, at operation 580, the AD 120 may generate an authorization for the payment requested. The process may then end.

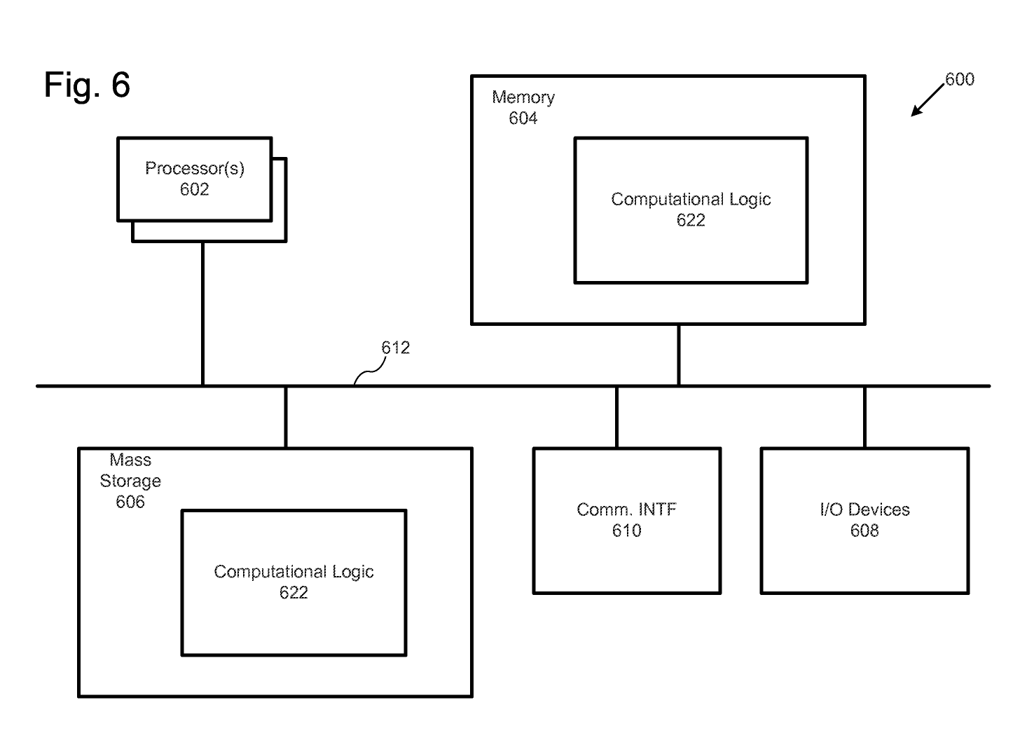

Referring now to FIG. 6, an example computer suitable for practicing various aspects of the present disclosure, including processes of FIGS. 2-5, is illustrated in accordance with various embodiments. As shown, computer 600 may include one or more processors or processor cores 602, and system memory 604. For the purpose of this application, including the claims, the terms “processor” and “processor cores” may be considered synonymous, unless the context clearly requires otherwise. Additionally, computer 600 may include mass storage devices 606 (such as diskette, hard drive, compact disc read only memory (CD-ROM) and so forth), input/output devices 608 (such as display, keyboard, cursor control, remote control, gaming controller, image capture device, and so forth) and communication interfaces 610 (such as network interface cards, modems, infrared receivers, radio receivers (e.g., Bluetooth), and so forth). The elements may be coupled to each other via system bus 612, which may represent one or more buses. In the case of multiple buses, they may be bridged by one or more bus bridges (not shown).

Each of these elements may perform its conventional functions known in the art. In particular, system memory 604 and mass storage devices 606 may be employed to store a working copy and a permanent copy of the programming instructions implementing the modules shown in FIG. 1, and/or the operations associated with techniques shown in FIGS. 2-5, collectively referred to as computing logic 622. The various elements may be implemented by assembler instructions supported by processor(s) 602 or high-level languages, such as, for example, C, that can be compiled into such instructions.

The permanent copy of the programming instructions may be placed into permanent storage devices 606 in the factory, or in the field, through, for example, a distribution medium (not shown), such as a compact disc (CD), or through communication interface 610 (from a distribution server (not shown)). That is, one or more distribution media having an implementation of the agent program may be employed to distribute the agent and program various computing devices. In embodiments, the programming instructions may be stored in one or more computer readable non-transitory storage media. In other embodiments, the programming instructions may be encoded in transitory storage media, such as signals.

The number, capability and/or capacity of these elements 610-612 may vary. Their constitutions are otherwise known, and accordingly will not be further described.

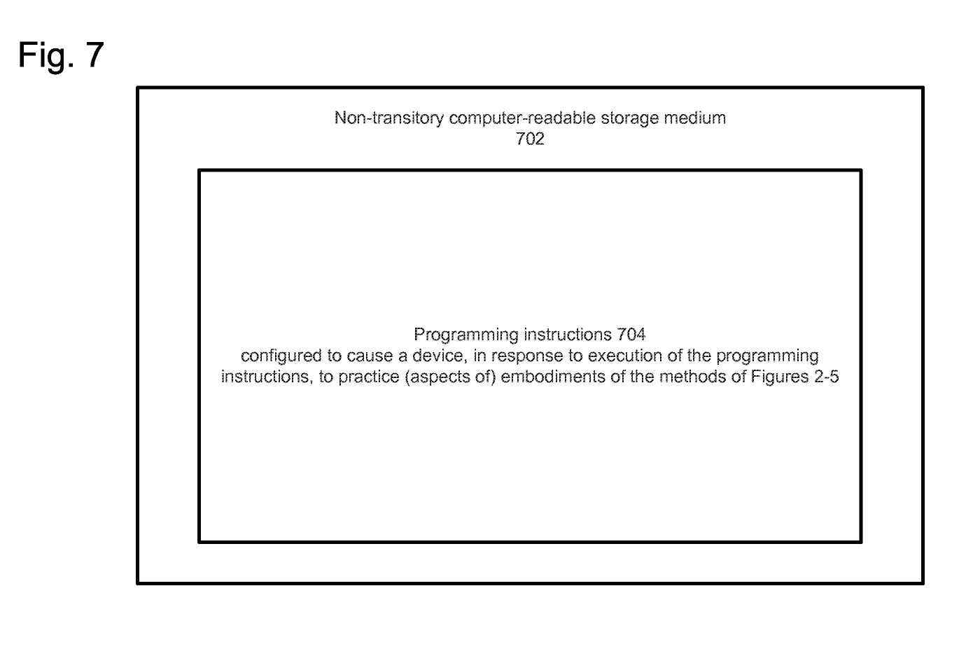

FIG. 7 illustrates an example least one computer-readable storage medium 802 having instructions configured to practice all or selected ones of the operations associated with the techniques earlier described, in accordance with various embodiments. As illustrated, least one computer-readable storage medium 702 may include a number of programming instructions 704. Programming instructions 704 may be configured to enable a device, e.g., computer 600, in response to execution of the programming instructions, to perform, e.g., various operations of processes of FIGS. 2-5, e.g., but not limited to, to the various operations performed to perform phone-number-based payment authorization. In alternate embodiments, programming instructions 704 may be disposed on multiple least one computer-readable storage media 702 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable media comprising instructions to cause a computing system, in response to execution by the computing system, to facilitate payments, wherein the computing system is caused to:
receive a payment authorization request from a requesting party to confirm that a payer party has financial resources to make a payment, wherein the request message identifies a payment amount and a phone number associated with the payer party;
in response to receipt of the authorization request, determine whether the first party has the financial resources to make the payment; and
in response to a determination that the first party has the financial resources to make the payment, send a confirmation to the requesting party that the payer party is capable of performing the payment.

2. The one or more computer-readable media of claim 1, wherein determine whether the first party has the financial resources to make the payment comprises:
send a request, to a payment authorizer, for a determination of whether the payer party has the financial resources to make the payment; and
receive a response from the request sent to the payment servicer.

3. The one or more computer-readable media of claim 1, wherein determine whether the first party has the financial resources to make the payment comprises request information from a payment servicer.

4. The one or more computer-readable media of claim 3, wherein the payment servicer holds one or more accounts associated with the payer party.

5. The one or more computer-readable media of claim 4, wherein the payment servicer holds a credit account associated with the payer party.

6. The one or more computer-readable media of claim 4, wherein the payment servicer holds a checking or savings account associated with the payer party.

7. The one or more computer-readable media of claim 1, wherein determine whether the first party has the financial resources to make the payment comprises perform a determination of whether the payer party has the financial resources to make the payment based on financial information available to the computing system.

8. The one or more computer-readable media of claim 7, wherein the financial information available to the computing system includes one or more of: account information, account type information, financial history, or account balances.

9. The one or more computer-readable media of claim 1, wherein receive a payment authorization request comprises receive a text message request.

10. The one or more computer-readable media of claim 1, wherein receive a payment authorization request comprises receive a request from the payer party.

11. The one or more computer-readable media of claim 10, wherein send a confirmation to the requesting party comprises send a confirmation code.

12. The one or more computer-readable media of claim 11, wherein the computing system is further caused to:
receive the previously sent confirmation code from an other party other than the payer party; and
send a confirmation message to the other party that the payer party has the financial resources to make the payment.

13. An apparatus for facilitation of payments, the apparatus comprising:
one or more computing processors; and
logic to operate on the one or more computing processors to:
receive a payment authorization request from a requesting party to confirm that a payer party has financial resources to make a payment, wherein the request message identifies a payment amount and a phone number associated with the payer party;
in response to receipt of the authorization request, determine whether the first party has the financial resources to make the payment; and
in response to a determination that the first party has the financial resources to make the payment, send a confirmation to the requesting party that the payer party is capable of performing the payment.

14. The apparatus of claim 13, wherein determine whether the first party has the financial resources to make the payment comprises:
send a request, to a payment authorizer, for a determination of whether the payer party has the financial resources to make the payment; and
receive a response from the request sent to the payment servicer.

15. The apparatus of claim 13, wherein determine whether the first party has the financial resources to make the payment comprises request information from a payment servicer.

16. The apparatus of claim 15, wherein the payment servicer holds one or more accounts associated with the payer party.

17. The apparatus of claim 13, wherein determine whether the first party has the financial resources to make the payment comprises perform a determination of whether the payer party has the financial resources to make the payment based on financial information available to the apparatus.

18. The apparatus of claim 17, wherein the financial information available to the apparatus includes one or more of: account information, account type information, financial history, or account balances.

19. The apparatus of claim 13, wherein receive a payment authorization request comprises receive a request from the payer party.

20. The apparatus of claim 19, wherein send a confirmation to the requesting party comprises send a confirmation code.

21. The apparatus of claim 20, wherein the logic is further to:
receive the previously sent confirmation code from an other party other than the payer party; and
send a confirmation message to the other party that the payer party has the financial resources to make the payment.

22. A computer-implemented method for facilitating payments, the method comprising:
receiving, by a computing system, a payment authorization request from a requesting party to confirm that a payer party has financial resources to make a payment, wherein the request message identifies a payment amount and a phone number associated with the payer party;
in response to receipt of the authorization request, determining, by the computing system, whether the first party has the financial resources to make the payment; and
in response to a determination that the first party has the financial resources to make the payment, sending, by the computing system, a confirmation to the requesting party that the payer party is capable of performing the payment.

23. The method of claim 22, wherein determining whether the first party has the financial resources to make the payment comprises:
sending a request, to a payment authorizer, for a determination of whether the payer party has the financial resources to make the payment; and
receiving a response from the request sent to the payment servicer.

24. The method of claim 22, wherein determining whether the first party has the financial resources to make the payment comprises requesting information from a payment servicer.

25. The method of claim 24, wherein the payment servicer holds one or more accounts associated with the payer party.

26. The method of claim 22, wherein determining whether the first party has the financial resources to make the payment comprises performing a determination of whether the payer party has the financial resources to make the payment based on financial information available to the computing system.

27. The method of claim 26, wherein the financial information available to the computing system includes one or more of: account information, account type information, financial history, or account balances.

28. The method of claim 22, wherein receiving a payment authorization request comprises receiving a request from the payer party.

29. The method of claim 22, wherein sending a confirmation to the requesting party comprises sending a confirmation code.

30. The method of claim 29, further comprising:
receiving, by the computing system, the previously sent confirmation code from an other party other than the payer party; and
sending, by the computing system, a confirmation message to the other party that the payer party has the financial resources to make the payment.
